(19) United States
(12) Patent Application Publication
(10) Pub. No.: US 2013/0177865 A1
(43) Pub. Date: Jul. 11, 2013

(54) System and Method for Performing Endodontic Procedures with Lasers

(71) Applicant: Calvin D. Ostler, Riverton, UT (US)

(72) Inventor: Calvin D. Ostler, Riverton, UT (US)

(73) Assignee: DENTSPLY INTERNATIONAL INC., York, PA (US)

(21) Appl. No.: 13/733,922

(22) Filed: Jan. 4, 2013

Related U.S. Application Data
(60) Provisional application No. 61/583,644, filed on Jan. 6, 2012.

(51) Int. Cl. A61C 1/00; A61C 5/04; A61C 5/02

(52) U.S. Cl. CPC A61C 1/0046; A61C 5/02; A61C 5/04
USPC 433/29; 433/224

(57) ABSTRACT

Disclosed herein is an apparatus and method of using a laser system or ultraviolet radiation to conduct endodontic procedures, such as root canal procedures.

This patent application claim priority to U.S. Provisional Patent Application No. 61/583,644, filed Jan. 6, 2012.

### BACKGROUND

There are several steps involved in a root canal procedure. These steps include, but are not limited to, opening the occlusal surface of the tooth to gain access to the root and root canal, removing the root and shaping the canal, debriding and sterilizing the canal, temporarily sealing the canal, and ultimately permanently sealing the canal and rebuilding the occlusal surface after subsequent infection has clear or after the threat of infection has cleared. Current state of the art or gold standards methods used to complete these steps include but are not limited to placing the patient on an antibiotic if infection is present for some time frame prior to proceeding. The antibiotic is sometimes prescribed and taken for a period of time prior to opening the tooth. In other situations, the tooth is opened and then the patient is placed on the antibiotic and must take the antibiotic for some number of days prior to proceeding with treatment. In yet other cases, the procedure may be completed to include the temporary filling and then the patient is placed on the antibiotic and takes the medication for the prescribed amount of time before the tooth is closed permanently. The timing, type, and length of treatment with an antibiotic varies depending on the specific issue to resolve and the patient. The dentist assesses the parameters and initiates the appropriate course of therapy. Aside from the antibiotic decision, one method for opening the tooth is to use dental high speed hand piece and an appropriate bur. One standard for pulp or root removal and canal shaping is with endodontic files. The debridement standard is irrigation with water and/or irrigation with a disinfectant such as EDTA or Sodium Hypochlorite. Disinfection or sterilization standard is the use of chemical methods such as EDTA or dilute bleach solution whether the disinfectants are employed during the irrigation to remove pulp fragments, subsequent to that procedure or both. The root canal is then dried and sealed with a temporary filling and the patient instructed to return at a prescribed later date to insure that no infection takes hold or that the current infection is gone. Upon return, the temporary filling is removed, the canal is checked and if clear, the tooth is rebuilt into a functional unit in a ‘permanent’ manner.

### SUMMARY

Disclosed herein is a dental laser device, comprising a laser system capable of producing at least three different wavelengths simultaneously or independently, where the first wavelength in a mid-infrared range, the second wavelength in a visible to near ultra violet spectrum range, and the third wavelength that is capable of sterilization. Further disclosed is a method of using such a dental laser device.

### BRIEF DESCRIPTION OF THE DRAWINGS

FIG. 1 depicts a method of conducting an endodontic procedure according to one embodiment described herein.

FIG. 2 depicts one embodiment of the laser device described herein.

FIG. 3 depicts another embodiment of the laser device described herein.

### DETAILED DESCRIPTION

In the last couple of decades of the twentieth century the use of lasers to cut hard tissue such as teeth was explored and a couple of different wavelengths and types of lasers emerged as potential candidates.

One example is Erbium:Yitrrium Aluminum Garnet laser. The lasing medium in this type of laser is the chemical element Erbium. The Erbium is suspended in a prescribed quantity within a matrix. The suspension of the medium is referred to as doping, such as “doped with Erbium”. The matrix in this case is comprised of the elements Yttrium and Aluminum and the mineral complex Garnet. This matrix forms a crystalline ‘glass’. The acronym YAG is used to describe this glass. The acronym Er:YAG is used to describe the Erbium-YAG laser. This Erbium doped crystal is then energized with light. The light passes through the glass and is absorbed by the Erbium. The electrons within the Erbium jump to a higher state of energy and then drop off. When the electron drops off it throws of the excess energy in a small packet called a photon, commonly known as a ray of light. This photon travels through the matrix until it strikes another Erbium atom. The Erbium atom absorbs the photo and is thereby stimulated into a higher energy state. The Erbium atom then returns to the lower energy state and emits two photons of light at exactly the same wavelength as the photon that stimulated the Erbium. These two photons are traveling in exactly the same direction as well. Two rays of light for one that was put in stimulating the Erbium was obtained. This makes the light brighter or amplifies the light, resulting in the phenomenon of Light Amplification by Stimulated Emission of Radiation or LASER. To enhance this amplification, mirrors are placed at the ends of the crystal. One mirror reflects all of the emitted light. This mirror is referred to as the “High Reflector”. Another mirror exactly parallel with the high reflector is placed at the opposite end of the crystal. This mirror allows a prescribed percentage of the light to escape. This is where the laser beam is emitted from the crystal. This mirror is known as the “Output Coupler”. How long the crystal is, what the percentage of doping, and the percentage of reflectance or emittance of the output coupler determines the so called “gain” of the laser. In other words, the more times photons bounce back and forth between the mirrors the more photons that are absorbed by the medium, which in turn emits two more photons to be absorbed by two more medium which in turn produces four photons, and the light is amplified. One other factor that determines how bright the laser beam will be is how much energy is pumped into the Erbium.

The color of the light produced by the laser is dictated by the medium. Erbium produces a wavelength of 2,940 nanometers in length which falls in the mid infrared region. The wavelength and intensity prescribes the use of the particular laser. In the case of Erbium and dentistry, 2,940 nanometers is absorbed by water better than any other wavelength. Actually it is 2,950 nanometers that absorbs absolutely the best and has an absorption coefficient of 12,649. What the number means is not important; the magnitude is the important point. By way of comparison another medium that has been used in ‘cutting’ hard tissue such as teeth is a mixture of Erbium and Chromium in a glass matrix comprised of Yttrium, Scandium, Gallium and Garnet (Er,Cr:YSGG). This medium produces a wavelength of 2,790 nanometers and is the closest wavelength to Er:YAG's 2,940 nanometer wavelength under investigation in hard tissue surgery. However, this 150 nanometer difference in wavelength makes a difference of 7,533 in water absorption coefficient. The water absorption coefficient of the Er,CR:YSSG hard tissue laser is 5,151, the Er:YAG is 12,649. Water absorbs Er:YAG energy 242% better than it absorbs Er,Cr:YSGG energy.

It is critical to understand this difference because not only the cutting of hard tissue but a large portion of the present disclosure pivots around the ability of water to absorb this energy and turn from liquid water to steam so fast it would be considered explosively converted. The fact that one of the lasers is 242% more efficient means it will be nearly three times as effective. There are other considerations for the choice of wavelength such as the means in which the energy can be transmitted to the target. Er:YAG has limitations that Er, Cr,:YSGG overcomes to some degree in this area.

As one of ordinary skill is aware, there are two major wavelengths available in the area of extreme water absorption, 2,790 nm produced by the Er, Cr, YSGG and 2,940 nm produced by Er:YAG. The water absorption coefficient of 2,940 is 242% better than the water absorption coefficient of 2,790 nm. However, one can transmit 2,790 nm through a fiber or wave guide, it is not possible to transmit 2,940 nm through a fiber or waveguide. 2,940 nm is usually transmitted through an articulating arm with mirrors. So on the one hand 2,790 nm is much easier to deliver but is far less effective. 2,940 nm is the best in terms of efficacy but is much more difficult to deliver and keep in alignment.

Now the midrange infrared wavelengths with high water absorption coefficients have not been chosen for hard tissue surgery because they work directly on teeth, rather they have been chosen because they convert liquid water into a mist form which is sprayed around the tooth into steam, explosively. This initiates a shock wave which literally chips the tooth or bone. It is the shockwave produced by the water changing from liquid to steam suddenly and explosively that chips away at the tooth. The wavelengths themselves are ineffective at removal of hard tissue without the mist of water. This explosive conversion of a solid to a gas by light and the subsequent shockwave is referred to as “Photoacoustics”. Much interest and experimentation has been done in the past on this Sonic Chemistry using ultrasonic transducers. However, the results of these studies have been somewhat disappointing as the ultrasonic wavelengths have not been the correct length to generate optimal results. This area as applied to lasers and dentistry and the disclosure herein is not simply interesting because of its possibilities in tooth whitening but free radicals are also involved in the destruction of microorganisms. The ability to produce short lived free radicals by Laser Induced Photoacoustic Sonic Chemistry lends itself to an entirely new and novel manner of oral cavity sterilization, including sterilization of the root canal. A new use for these wavelengths in endodontic applications combined with the possibility of also generating microorganism killing free radicals with the same wavelengths as described herein results in a novel dental instrument.

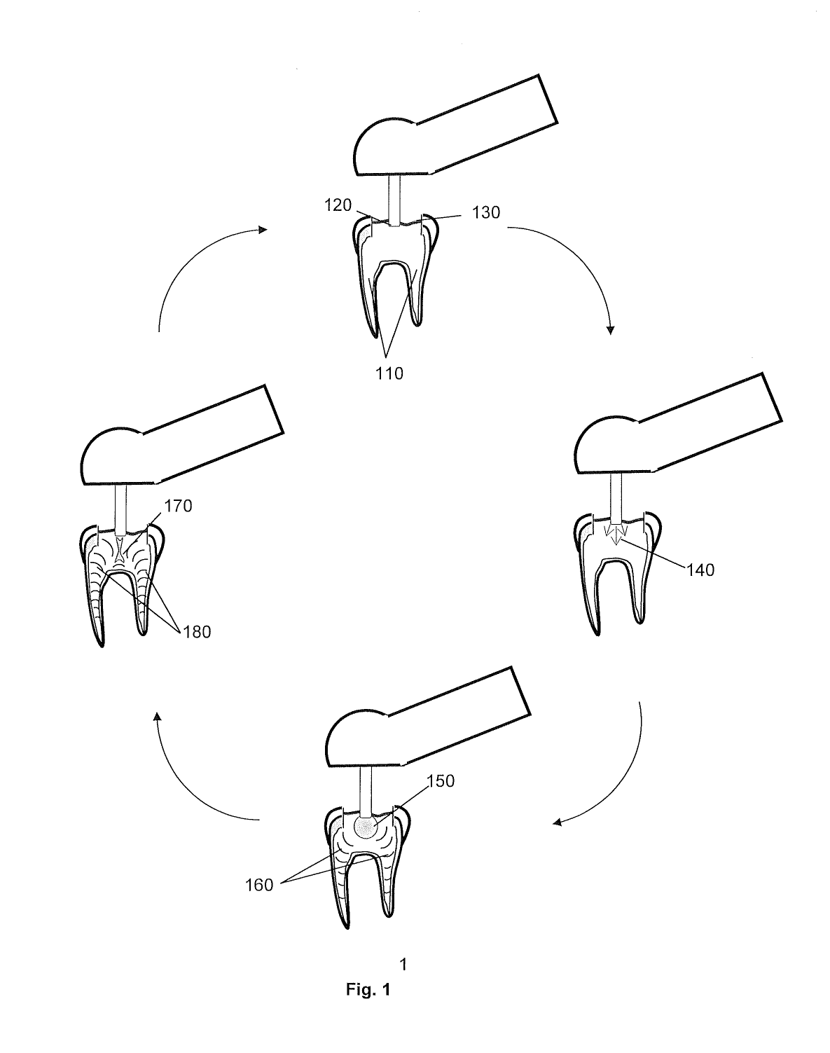

PIPS (Photon-Initiated Photoacoustical Streaming) is emerging as, potentially, a replacement for methods of debriding and irrigating the canal after the pulp has been disrupted or chewed into pieces, currently by the endodontic file. In this procedure, referring to FIG. 1, the root canal (110) is filled with water and the very tip of a quartz or fused silica fiber delivery tip (120) is placed into the water, just below the surface of the water (130). A moderate amount of mid-infrared wavelength energy, some 20 millijoules of 2,940 nanometer, is emitted (140) into the very top portion of the water filled root canal. Relative to the vast amount of water in the root canal, a few water molecules are explosively converted to steam immediately causing a steam bubble (150) to form at the tip of the fiber. This causes a shockwave (160) which is propagated by the water to the very corners of the root canal. The burst of energy is very short lived some 50 or so microseconds. The then, again relatively, vast quantity of water in the canal immediately cools the steam converting it to liquid and causing the bubble to collapse (170). This in turn causes a vacuum sucking the water back against the fiber tip, initiating a shockwave (180) in the opposite direction which propagates to every corner of the root canal. This process (cycle depicted in FIG. 1) is repeated at a rate of approximately 15 cycles per second. As a testament to the very small quantity of molecules explosively converted from liquid to steam and back to liquid again, a 40 second PIPS treatment only increases the water temperature 1.5° C. while a 20 second treatment increased the water temperature in the root canal 1.2° C. The effect of these pressure waves created by PIPS is that of a pressure washer used to clean paint from masonry or concrete. The findings are a complete removal of the smear layer with open dentinal tubules. Simply put, all of the biological material may be scrubbed off of the inner surfaces of the root canal. Disclosed herein, UV-C band laser radiation may be used to sterilize the canal during PIPS. Further, Free Radical Generation by way of Laser Induced Photoacoustic Sonic Chemistry as discussed herein could provide simultaneous sterilization by way of free radical generation and the attack of the free radical on the offending microorganisms.

PIPS itself and the streaming of fluids may damage some microorganisms however the streaming nature of the shockwaves flush out and reduce the raw number of microorganisms in the root canal which would account to the reduced bacteria related in Olivi's conclusions. PIPS clearly is advantageous over current methods of debridement. However, lasers may also offer a large advantage over the endodontic file for pulp removal as well.

Historically, surgical lasers capable of removing tissue where comprised of three general types. First the carbon dioxide laser in which carbon dioxide was/is the medium and that medium produces a far infrared wavelength of 10,600 nanometers. Nd:YAG (Neodymium doped YAG crystals) which produced a near infrared wavelength of 1064 nanometers and the Argon Ion laser. Argon Ion and Carbon Dioxide lasers are both “pumped” the same way. Both are turned into plasma by conducting electricity through them. As a neon sign lights up when you plug it in, carbon dioxide and argon will also light up. Then, in an extremely over simplified statement: if correct mirrors are put in place laser action will occur. Carbon dioxide plasma may also be generated by the injection of radio frequencies. In any event the Argon Ion lasers produce a visible blue and green range of wavelengths depending on the mirrors. Carbon Dioxide has a water absorption coefficient of 792, Nd:YAG has a water absorption coefficient of 0.12. Visible green produced by the Argon Laser has a water absorption coefficient of 0.00025. Water does not absorb visible green. But it does absorb Nd:YAG and Carbon Dioxide, all be it to a far lesser extent than Er:YAG. However, water does absorb Nd:YAG and Carbon Dioxide well enough to be used in soft tissue ablative surgery. Ablation of a cell is when the cell absorbs the energy, in the case the water in the cell, causing the cell to expand rapidly and break apart (explode). In the case of the infrared laser, it is the water. Other proteins and components within a cell may also contribute to such ablation. Looking again at the water absorption coefficient for visible green, 0.00025, it would take a lot of visible green to even start to heat just a molecule of water. The coefficient is so low that it is actually a conductor of green light. Water propagates green and blue light, absorbing very little. On the other hand, the coefficient for hemoglobin without attached oxygen is 40,584 and with oxygen attached is 43,876. That coefficient for hemoglobin drops to approximately 206 and 1024 at Nd:YAG wavelength range and is virtually non-existent in the other wavelengths, hence those wavelengths have little or no effect on coagulation of blood. But visible green does. The Argon Ion lasers used, historically, in dentistry were capable of putting out 10 watts at maximum and are continuous output lasers, meaning that they turn on and a beam comes out. The Er:YAG discussed in PIPS is a pulsed laser. The duration of the pulse is 50 microseconds (0.000005 seconds). At 20 millijoules and 15 Hz each pulse of energy in the PIPS procedure from the Er:YAG is producing 400 watts of energy. Because of this 400 watts and the high absorption coefficient, water is explosively turned to steam. If the same laser delivered 10 watts continuously to the water, the water would simply boil. When 10 watts of Argon green is delivered to a blood rich tissue like pulp, the tissue burns away as the water boils with 10 watts of Er:YAG. If, on the other hand, visible green could be delivered in high wattage pulses like the Er:YAG delivers its wavelengths, the hemoglobin would absorb it and fly apart as liquid turns to steam in the Er:YAG-water scenario. Unfortunately, Argon lasers cannot deliver high wattage very short pulses of energy for any kind of reasonable price or size. Now Nd:YAG can be pulsed with the same flash lamp that the Er:YAG is and can get similar powers. Unfortunately the Nd:YAG may be absorbed by the water in the canal and in the dentinal tubules and damaged the teeth as well as performed poorly on pulp removal in the confines of the root canal. The Nd:YAG may perform well on gums and other soft tissues in the mouth that are not confined within the rigid bone structure of the root canal.

These lasers generally did not perform well at removing pulp until the introduction of the diode laser. In simple terms, the diode laser is a light emitting diode (LED) with mirrors on the end. These diodes have only been available at high enough power levels to perform surgery in the near infrared range, most commonly 810 and 980 nanometers. Dentists soon learned that they needed virtually no energy at all, 1-3 watts, to heat up a glass fiber and use it to burn tissue away. That is to say the laser beam is shot down a glass fiber delivery system. If the end of the fiber is cut cleanly the beam will emit and could be absorbed by the tissue. The tissue would absorb the energy and if the energy level was high enough the cells would explode. What occurs in dentistry today is that the dentist blocks off the end of the fiber with a gob of plastic or other material. They call blocking the fiber off “tip initiation”. Once the tip is blocked off and the laser energy cannot escape the end of the fiber or tip heats up. The end of the fiber will get white hot in a few tenths of a second when exposed to just 2 or 3 watts of laser energy. With the white hot tip, the dentist proceeds to remove tissue quickly and efficiently by burning it away with the white hot tip of glass. Less thermal damage occurs this way than using the older electric surgical tools and so the wounds may heal quicker and cleaner (reportedly). The point is that because the laser diodes are so small and cheap, laser diodes became the mainstay and all other lasers have drifted into very little usage. As is clear from this description, any known laser system may be used in the dental system described herein.

Just about the time that the diodes started to gain ground companies began to produce Nd:YAG pulsed lasers that put out visible green light. However, crystal lasers that are pumped with other lasers such as diodes can be of importance to the invention. Diode lasers, for instance as a pumping source, can be turned on and off very quickly and could be used to pump the crystal to obtain wavelengths, peak powers, and short time frames useful to the invention. Of major importance is that very short, 50 microsecond, and very high power in pulses of visible green are possible and practical with the frequency doubled Nd:YAG crystal. In simple terms, the 1064 nanometer wavelength is directed through a non-linear crystal which doubles the frequency, from 1064 to 532 nanometers. The 1064 nanometer wavelength can, similarly, produce other harmonics such as 355 nanometers and 266 nanometer wavelength. 266 is in the UV-C band and is defined by NSF and ANSI as microorganism-cidal capable of killing 99.9% of all microorganisms tested in, relatively, very low doses of radiation. Such pulses of 532 nanometers would literally blow short (actually to a prescribed length) sections of pulp into fine pieces. Because water transmits the wavelength it could be done during the process of PIPS. Further, current technology affords flash chambers that have a flash lamp for pumping in the middle with an Er:YAG crystal on one side and a Nd:YAG crystal on the other side: the beams can be produced simultaneously within the same flash chamber pumped by the same flash lamp, powered by the same power supply, cooled with the same cooling system, controlled by the same electronic and software package and interfaced with the same user interface; touchscreen display or other interface. Again, as explained above, one of skill in the art will readily understand that any laser could be used in place of the flash lamp described herein, for example, a diode laser.

In clarifying the wavelength without limiting the conversation to specific wavelengths, one is looking for a wavelength for PIPS that is absorbed well by water, such as mid infrared wavelengths, or wavelengths of from about 2850 nm to about 3050 nm, a wavelength for pulp ablation that the pulp or components of the pulp absorb well but are not absorbed by media that could potentially interfere with the pulp absorption such as a root canal filled with or contains some quantities or droplets of water, such as visible blue and green wavelengths, or wavelengths of from about 400 nm to about 560 nm. Additionally, as discussed herein, are wavelengths that are useful in sterilization of the root canal, such as wavelengths confined to the UV-C bandwidth, or wavelengths of from about 200 nm to about 290 nm. Wavelengths useful in the present disclosure for sterilization of the root canal are certainly those wavelengths that directly kill or deactivate a microorganism's ability to replicate such as the UV-C band wavelengths. However, other wavelengths that could eliminate a microorganism's threat of developing into an infection by other means are certainly useful to the invention. Such wavelengths might also be used in association with PIPS or the removal of pulp, reshaping the root canal or even locating the apex. For instance, 355 nanometer wavelength radiation is a harmonic of 1064 nanometer and is produced from Nd:YAG crystal. 355 nanometer is closer to UV-C than 532 but is also absorbed by hemoglobin with extinction coefficients without oxygen of 128,776 and with oxygen of 103,696. The coefficients suggest that 355 nanometer is well more than twice as effective on hemoglobin as 532, however, its water absorption coefficient is 0.00233 which almost exactly 10 times greater than that of 532 nanometers. Because it is twice as efficient and the water absorption is, relatively, tiny 355 nanometer may be a better wavelength for pulpal ablation plus 355 falls within the UV-A band (320-400 Nanometers) which may have some other use in the process, perhaps even some sterilization effect although, UV-A alone has not been shown to be very effective at reducing infections. The combinations of several factors or variables could, potentially, make it useful. The point is made, the selection of the wavelength with its RELATIVE differences to the other wavelengths and combining them appropriately to complete the root canal procedure is the invention. Specific examples are illustrative only and not meant to be restrictive in any way, shape or, form.

As mentioned, a harmonic of 1064 nanometer laser light generated by Nd:YAG is 266 nanometers. 266 Nanometer wavelength falls within a subsection of the electromagnetic spectrum referred to as the ultraviolet spectrum or UV spectrum. The entire UV spectrum output from the sun and then arriving on earth through the filtration of the atmosphere comprise 8.3 percent. The remaining 91.7% is comprised of other wavelengths most of which are in the visible and infrared portion, such as 1064 nanometer and 2940 nanometer, of the electromagnetic spectrum. The UV spectrum is comprised of three major portion separated and categorized by their effects. These three major portions are:

First: UV-A band comprised of the wavelengths 320-400 nanometers. Wavelengths above 400 nanometer enter into the visible violet/blue region of the electromagnetic spectrum. At 6.3 percent UV-A radiation comprises the vast majority of UV's 8.3 percent of total radiation striking the earth's surface. Suntans are related to UVA exposure, but not sun BURNS. They do not cause sunburns because of their lower energy than UVB or UVC. The long waves of UVA generates free radicals and causes indirect DNA damage which is responsible for malignant melanoma. Since UVA penetrate deeper they damage collagen fibers and destroy vitamin A.

Second: UV-B radiation is comprised of the wavelengths 290-320 nanometers and comprise 1.5 percent of the total radiation. UV-B band radiation is the band associated with most ill effects on organisms. The photons are high enough in energy to damage cells, the band is absorbed by the skin in animals through the epidermis. Subsequently, erythema or “sunburns” are related to UVB exposure. Symptoms depend on the intensity and or length of the exposure. Skin cancer, the most deadly form malignant melanoma, is caused by indirect DNA damage from UVB. Direct photochemical damage to DNA also causes skin cancers. One positive affect of moderate doses of UVB is that in induces the production of vitamin D and vitamin K.

Third: UV-C radiation is even higher in energy than UV-B. As mentioned earlier UV-C band radiation is comprised of the wavelengths 200-290 nanometers. Solar source of UV-C radiation is of little concern to living organisms because of the concentration is so low, only comprising about ½ of one percent of total solar radiation striking the earth. Further, the wavelength has little penetrating power, unable to even penetrate the epidermis and therefore affecting only the surface of the epidermis. Hence, UVC is considered the safest type of UV radiation to be exposed to since it cannot penetrate the skin's outermost layer. However, commercial sources of UV-C radiation may be a cause for concern as they generate much higher intensity than is delivered by the sun, through our atmosphere. The most common injuries of UVC are corneal burns and erythema or severe skin burns. UVC burns are painful, but most injuries are short lived. Potentially, excessive exposure to UVC may cause skin cancers.

Photons at UVC wavelengths, in high enough doses, kill or deactivate the replication abilities of microorganisms by interacting with and damaging organelles within the cell. Hence the UVC radiation band has germicidal effects with the most effective wavelength being 264 nanometers. ‘Sterilizing’ doses as defined as destroying or deactivating replicative abilities of microorganisms has been defined by NSF/ANSI Standard 55, for the treatment of water, to be 40 Milliwatt seconds/centimeter². Of course, different microorganisms require different doses. Further, longer exposure times at the same power or greater output power for an equal time results in a higher percentages of destruction or replicative deactivation. For instance Bacillus Subtilis requires 5.8 milliwatt seconds/centimeter² to destroy or replicative deactivation of 90% of a growth colony. Whereas a dose of 11 milliwatt seconds/centimeter² results in the destruction or replicative deactivation of 99% of a growth colony comprised of the same species. By way of illustration, a very tough virus such as Tobacco Mosaic may require as much as 440 milliwatt seconds/centimeter² to destroy or replicative deactivation of 99% of a growth colony. The most commonly found, problematic, organisms found in the root canal and mouth are of the easiest varieties to destroy, which are comprised of bacteria, viruses (influenza etc), and yeasts requiring doses of less than 28 milliwatt seconds/centimeter², only 70% of the dose required to convert sewage water to potable water. As the pulsed Nd:YAG at a ridiculously low 10% conversion rate of 1064 to 266 nanometers would supply 100 times more energy that required, 500 milliwatt continuous, it is clear that the 266 harmonic of the Nd:YAG would be useful in sterilizing the canal. Such a method of sterilization of the root canal with UV-C radiation with the same instrument has clear advantages. 266 nanometer radiation being produced by the same instrument could be introduced simultaneously with other wavelengths. For instance, after the pulpectomy 266 nanometer radiation could be introduced during additional PIPS debridement.

It should be additionally noted that the conduction and or transmission of all of these wavelengths can be accomplished with short sections of quartz or it's synthetic equivalent fused silica. The loss rates are quite high for the 2940 wavelength but are acceptable for short distances, a couple of centimeters or less. Quartz is virtually transparent to UVC through short infrared wavelengths: 240-1064. All of the wavelengths are deliverable from the resonator to the short piece of crystal by way of an articulating arm. Further, lower, relative power levels, those capable of PIPS are transmittable through treated hollow glass fibers termed “waveguides”. One manufacturer, Polymicro Technologies, LLC of Pheonix, Ariz., claim up to 1000 watts are deliverable with losses near 0.02 dB. These energy levels would also facilitate, potentially, opening the tooth and shaping the canal with photoacoustic manipulation of the mid-infrared wavelengths such as the 2940 nanometers emitted by the Er:YAG. In fact, it may be possible at slightly higher power levels than PIPS to perform both PIPS and canal shaping at the same time in a canal full of water while simultaneously ‘injecting’ therapeutic doses of UV-C to sterilize the canal.

### System Example 1

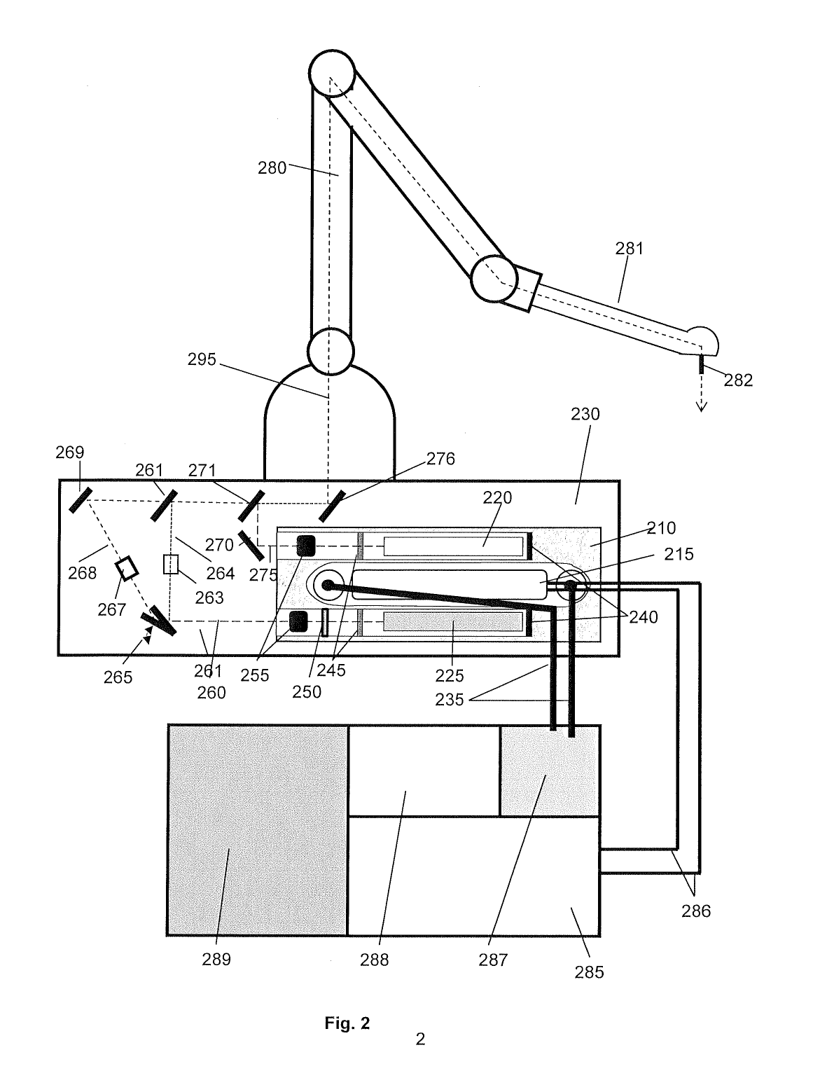

Referring to FIG. 2, a dual flash chamber consisting of a housing (210), a flash lamp (215), an Er:YAG crystal (220), and an Nd:YAG crystal (225) are positioned into a resonator housing (230). A cooling method (235), in this case recirculating water, is positioned to cool the flash chamber. High reflector mirrors (240) are position at the non-output end of the resonator housing (230). Partially reflective mirrors tuned to appropriate wavelength (245) are placed at the output end of the resonator housing (230). A “Q” switch (250) may be incorporated into either crystal, in this case it is placed for functioning with the Nd:YAG crystal (225). Optics (255) capable of shaping or focusing their respective beams as requisite are also mounted in the housing (230). The Nd:YAG crystal (225) emits a 1064 nanometer beam (260) that strikes a mirror (261), which directs the beam to a non-linear crystal (263) which in turn produces a 266 nanometer beam (264). The 1064 mirror (260) is capable of pivoting (265) to redirect the 1064 beam through a second non-linear crystal (267) which produces a 532 nanometer beam (268). The Er:YAG crystal produces a 2940 nanometer beam (275) which is directed to a mirror (270) which in turns directs the beam to a mirror (271) which reflects 2940 nanometers but transmits 266 nanometer and 532 nanometer wavelengths. If the 1064 mirror (260) is in a position to direct the beam through the non-linear crystal (263) which produces 266 nanometer beam (264) that beam strikes a mirror (261) which reflects 266 nanometer wavelength but transmits 532 nanometer wavelength. If the 1064 mirror (260) is positioned to direct the 1064 beam (260) through the non-linear crystal (267) which produces 532 nanometer beam (268) the 532 beam (268) strikes a mirror (269) which redirects the 532 beam direct through the 266 nanometer reflective mirror (268) and through the 2940 nanometer reflective mirror (271) causing the 532 nanometer beam (268) and the 2940 nanometer beam (275) to strike the all wavelength reflective mirror (276). If the 1064 reflective mirror (260) is in a position to direct the beam (260) to the non-linear crystal (263) which produces 266 nanometer wavelength (264), that beam will be directed by way of mirror (261) through the 2940 mirror (271) and combining with the 2940 beam at the all wavelength reflecting mirror (276). The all wavelength reflect mirror (276) directs all combinations of wavelengths (295) into the articulating arm (280). The articulating arm delivers all wavelengths to the hand piece delivery system (281). The delivery system could contain a short fiber made of quartz (282). In this way the system just described could deliver 2940 nanometer wavelength, 532 nanometer wavelength, or 266 nanometer wavelength independently to the desired target. Or it could deliver simultaneously combinations of 2940 and 532 nanometer radiation or 3940 and 266 nanometer radiation. This system requires a power supply (285) to drive the flash lamp (215) and other systems. It requires wires (286). It requires a pump and heat exchanger for the recirculating water (287), control electronics (288), and a user interface (289) to select and control the entire system. The entire resonator package including mirrors, articulating arm and delivery hand piece can be custom manufactured by MegaWatt of Hilton Head Island, S.C. The power supply can be custom manufactured by Lumina Power of Bradford Mass. Electrical engineering can be obtained from Design Test and Technology of Ann Arbor Mich. Production of the electrical assembly can be obtained from Newonics, of Salt Lake City, Utah. Industrial Design can be obtained from Trapezoid Design and Development of Chaska, Minn. Injection molding services can be obtained from Total Molding Services of Trumbauersville, Pa. Assembly-manufacturing of a medical or dental device can be done by RH-USA of Livermore, Calif.

### System Example 2

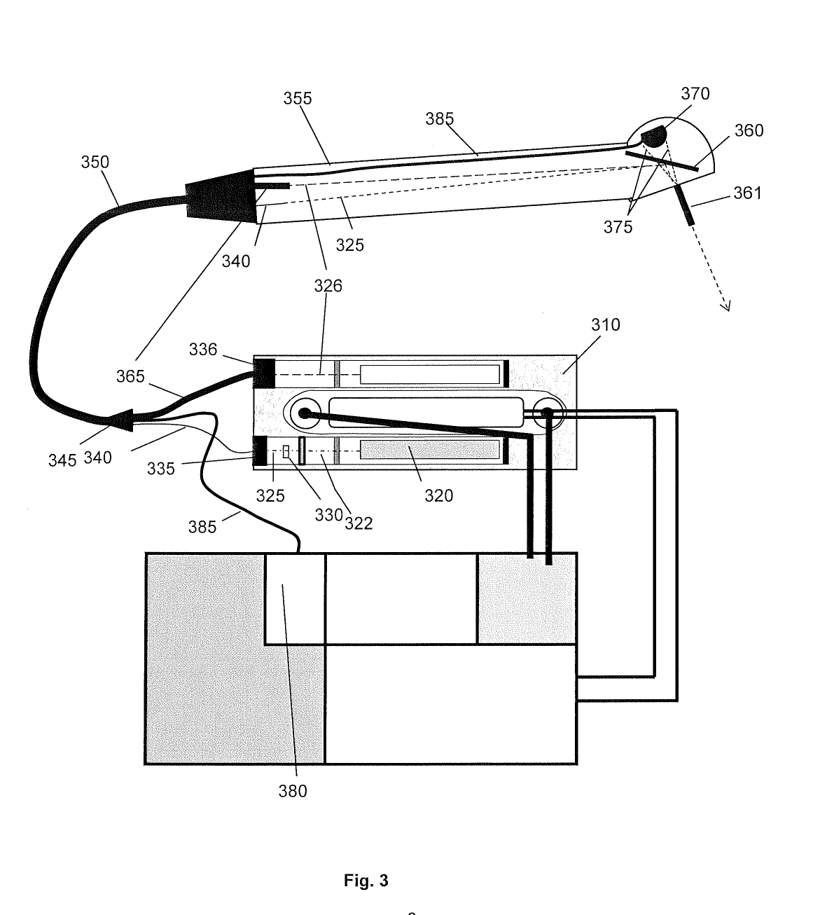

Referring to FIGS. 2 and 3, the dual flash chamber, flash lamp, mirrors and Q switch (310) are exactly as described in FIG. 2 and System Example 1 above. The difference in this system example is that the Nd:YAG crystal (320) is only going to produce 1 wavelength, 532 nanometer (325). The Nd:YAG 1064 nanometer wavelength (322) is directed through the non-linear crystal (330) and then into a lens or series of lenses (335) required to focus the beam into fiber optic delivery (340). The fiber optic deliver is, in turn, placed into (345) a suitable trunk conduit such as a stainless steel mono-coil (350). The fiber optic delivery (340) terminated into the hand piece delivery device (355) at an angle and including optics such that it will reflect off of the 532 and 2940 reflective but 260 nanometer transmission mirror (360) which directs the 532 nanometer wavelength (325) out the delivery tip (361) to the target. Likewise the Er:YAG crystal directs the 2940 nanometer wavelength (326) into a lens or series of lenses (336) capable of focusing the beam into a waveguide (365). The waveguide is, in turn, placed into (345) a suitable trunk conduit such as a stainless steel mono-coil (350). The waveguide (365) terminated into the hand piece delivery device (355) at an angle and including optics such that it will reflect off of the 532 and 2940 reflective but 260 nanometer transmission mirror (360) which directs the 2940 nanometer wavelength (325) out the delivery tip (361) to the target. In addition to these two lasers and unique to this system is the placement of a Light Emitting Diode (LED) (370) which produces UV-C radiation in the range of approximately 250 to 270 nanometer wavelengths (375). This LED (370) has a lens or directing cone constructed of Quartz or Silicone to collect and direct the UV-C radiation (375) through the delivery tip (361) to the target. The only addition to the power supply, cooling system, control electronics, and user interface would be additional electronics (380) and wires (385) required to drive, and control the LED (370). All of the vendors in System Example 1 are applicable to this system, however, none of those vendors can produce such an LED. Crystal IS of Green Island, N.Y. is the only current producer of LEDs of sufficient power output in the correct wavelength to be able to provide sterilization.

### System Example 3

The above two system examples illustrate embodiments with dual flash chamber, flash pumped crystal lasers to generate the desired wavelength. There are other methods of pumping crystal laser such as the use of diode lasers. That is to say, the flash lamp in the dual chamber listed above can be replaced with diode lasers of specific wavelengths which would pump the individual crystal lasers to an excited state which would then generate the desired wavelengths such as the 1064 nm wavelength produced from the Nd:YAG and the 2940 nm wavelength produced by the Er:YAG. For instance diode pumped Er:YAG lasers are commercially available from sources such as www.3 micron.com and diode pumped Nd:YAG lasers are commercially available from www.rpmclasers.com. There are also other sources for diode pumped and solid state lasers. Additionally excimer, pumped dye, plasma and diode lasers, including combinations thereof, capable of producing the usable mid infrared, visible blue through green, and UVC wavelengths are contemplated herein when configured properly. This example demonstrates that the present disclosure is not limited to specific devices for generating the wavelengths but is limited to the specific wavelength ranges disclosed herein, i.e., those wavelengths that are in a mid infrared range and capable of generating cavitation like pressure surges for dislodging particles and scrubbing/cleaning the inside of the root canal by of processes such as PIPS, wavelengths produced in the visible blue to green spectrum which are capable of passing through water with little effect while being highly absorbed by hemoglobin and proteins in cells causing them to ablate, and wavelengths in the UVC range capable of replicatively deactivating microorganisms in the root canal and thereby sterilizing the root canal. The further use of visible blue light sources from about 400 nanometers to about 500 nanometers could also facilitate the curing of dental filler material used to close the root canal completing the procedure.

### Method Example

Using systems capable of producing energy in the correct wavelength and format such as lasers and Light Emitting Diodes as described herein includes at least the following steps of preparing the patient, and opening the tooth. This may be done in a couple of ways either by high speed hand piece or with a laser capable of removing hard tissue. Perform a pulpectomy or pulpotomy as is dictated by the patient's needs and current dental practices. This can be accomplished in several ways by the use of endodontic files or by using lasers capable of ablating pulp without adversely affecting other elements in the canal such as water. Shape the canal. This can be done in a couple of ways with by use of a endodontic files or using lasers that produce wavelengths capable of removing hard tissue or inducing the removal of hard tissue through effects such as photoacoustic wave generation. Debride the coot canal. Again this can be accomplished several ways such as using conventional irrigation with or without the aid of endodontic files or one could use lasers capable of producing the debridement procedure of PIPS. Sterilize the root canal. There are a couple of choices here as well, use disinfectants such as sodium hypochlorite or EDTA, use PIPS with the disinfectants and/or use UV-C radiation with or without disinfectants and/or PIPS. Seal the tooth. As described earlier certain systems would allow the practitioner to perform some of these steps simultaneously.

One could even ablate the pulp with laser radiation of 532 or 355 nanometer wavelength while shaping and debriding the canal with a second wavelength of 2940 nanometers simultaneously. Then with the a simple input command continue with PIPS while 266 nanometer UVC radiation produced from the laser sterilizes the root canal as could be accomplished by the system in system example 1 above.

Further, one could use UV-C and PIPS to shape, debride and sterilize simultaneously with a dual wavelength laser. In addition, if one were to incorporate UV-C LEDs one could, theoretically, ablate the pulp, shape the canal, debride the canal and sterilize the canal simultaneously using a laser system capable of producing and delivering 2940 nanometers, and 532 or 355 nanometers simultaneously while the LED supplied sufficient quantities of UV-C band radiation to simultaneously destroy or replicative deactivate microorganisms as described in System Example 2 above.

Although the present disclosure has been described in detail with reference to certain illustrated exemplary embodiments, variations and modifications exist within the scope of one of ordinary skill in the art.

I claim:

1. A laser device, comprising a laser system capable of producing at least three different wavelengths,
a first wavelength in a mid-infrared range,
a second wavelength in a visible to near ultra violet spectrum range, and
a third wavelength that is capable of sterilization.

2. The laser device of claim 1, wherein the at least three different wavelengths are emitted from the device independently controlled by a user.

3. The laser device of claim 1, wherein the at least three different wavelengths are simultaneously emitted from the device.

4. The laser device of claim 1, further comprising a delivery system for the at least three wavelengths, an electrical system to power the device, a cooling system, and a user interface.

5. The laser device of claim 1, wherein the first wavelength is from about 2850 nm to about 3050 nm.

6. The laser device of claim 5, wherein the first wavelength is capable generating cavitation like pressure surges for dislodging particles and scrubbing or cleaning the inside of a dental cavity.

7. The laser device of claim 1, wherein the second wavelength is from about 400 nm to about 560 nm.

8. The laser device of claim 7, wherein the second wavelength is capable of passing through water while being highly absorbed by hemoglobin and proteins in cells causing the cells to ablate.

9. The laser device of claim 1, wherein the third wavelength is from about 200 nm to about 290 nm.

10. The laser device of claim 9, wherein the third wavelength is capable of sterilization.

11. The laser device of claim 1, wherein the second wavelength is from about 400 nm to about 500 nm and is capable of filling dental material.

12. The laser of claim 1, wherein the laser device is a dental laser device.

13. A method, comprising:
preparing a patient for a root canal procedure,
opening a tooth to begin the root canal procedure,
using a laser device to apply a first wavelength to ablate pulp, applying a second wavelength to initiate photoacoustic streaming to flush ablated pulp away and scrub biofilm from the root canal, and applying a third wavelength in order to sterilize the root canal,
inserting a material into the root canal to seal the opening.

14. The method of claim 13, wherein the first wavelength is from about 400 nm to about 560 nm.

15. The method of claim 13, wherein the first wavelength is from about 2850 nm to about 3050 nm.

16. The method of claim 13, wherein the third wavelength is from about 200 nm to about 290 nm.

17. The method of claim 13, wherein the first wavelength, second wavelength and third wavelength is applied independently or simultaneously.
